(19) United States
(12) Patent Application Publication
(10) Pub. No.: US 2009/0087269 A1
(43) Pub. Date: Apr. 2, 2009

(54) CUTTING TOOL

(75) Inventors: Jiro Motomura, Anjo-shi (JP); Koichi Ishikawa, Anjo-shi (JP); Kenichi Yamaya, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO. LTD., Anjo-shi (JP)

(21) Appl. No.: 12/240,542

(22) Filed: Sep. 29, 2008

(30) Foreign Application Priority Data
Sep. 28, 2007 (JP) 2007-253192

(51) Int. Cl. B26D 3/00

(52) U.S. Cl. 407/113

(57) ABSTRACT

A cutting tool for cutting a lead-free copper-based bearing alloy containing 75 to 95% by mass Copper(Cu):, 1 to 15% by mass Bismuth(Bi), and 1 to 10% by mass hard particles comprising metal phosphide, boride, or carbide. The Cutting tool includes a rake surface, a clearance surface, and a cutting edge formed on a line of intersection between the rake surface and the clearance surface. A tip end site including the cutting edge comprises a diamond tip, and the diamond tip comprises a sintered body formed by sintering diamond particles having an average particle diameter (D50) between 0.2 μm and 1.6 μm. The cross section of the cutting edge preferably has a curved surface shape with a radius of curvature between 10 μm and 50 μm.

### INCORPORATION BY REFERENCE

The disclosure of Japanese Patent Application No. 2007-253192 filed on Sep. 28, 2007, including the specification, drawings and abstract is incorporated herein by reference in its entirety.

### BACKGROUND OF THE INVENTION

1. Field of the Invention

The present invention relates to a cutting tool for cutting a lead-free copper-based bearing alloy that does not contain lead.

2. Description of the Related Art

Copper alloys containing lead (Pb) are widely used conventionally as a copper-based bearing alloy employed as a slide bearing (see Japanese Patent Application Publication No JP-A-H7-179964). However, with the recent increased awareness of environmental concerns, alloys containing lead as a component have been shunned, and demand for lead-free copper-based bearing alloys that do not contain lead has increased.

In light of this background, a lead-free copper-based bearing alloy comprising 75 to 95% by mass Copper(Cu), 1 to 15% by mass Bismuth(Bi), and 1 to 10% by mass hard particles comprising metal phosphide, boride, or carbide has been developed as a lead-free copper-based bearing alloy, whichexhibits a superior performance as a slide bearing.

A bearing alloy is used as a slide bearing after undergoing a final cutting process in which the bearing alloy is fashioned into a desired shape.

However, it has been found that when a bearing alloy having the composition discussed above is cut with a cutting tool having a typical cutting edge constituted by a so-called diamond tip (see Japanese Patent Application Publication No. JP-A-2007-54945), the cutting performance of the cutting edge is greatly deteriorated greatly in comparison to the cutting performance during cutting of a conventional lead-containing copper-based bearing alloy. This deteriation in cutting performance can lead to problems such as a reduction in cutting precision and a reduction in the life of the cutting tool.

### SUMMARY OF THE INVENTION

The present invention has been designed in consideration of the problems found in the related art, and it is an object herein to provide a specialized cutting tool for cutting a lead-free copper-based bearing alloy, which is highly durable and exhibits a superior cutting performance in relation to the lead-free copper-based bearing alloy described above.

An Exemplary embodiment of the present invention is directed to a cutting tool for cutting a lead-free copper-based bearing alloy, the alloy comprising 75 to 95% by mass Cu, 1 to 15% by mass Bi, and 1 to 10% by mass hard particles comprising metal phosphide, boride, or carbide, said cutting tool comprising a rake surface, a clearance surface, and a cutting edge formed on a line of intersection between the rake surface and the clearance surface,

characterized in that a tip end site including the cutting edge comprises a diamond tip, and

the diamond tip comprises a sintered body formed by sintering diamond particles having an average particle diameter (D50) between 0.2 μm and 1.6 μm.

The cutting tool of the present invention is a specialized cutting tool for cutting a lead-free copper-based bearing alloy having the specific composition described above and comprises a sintered body formed by sintering small-diameter diamond particles, which have the specific average particle diameter noted above. The Sintered body is used as the diamond tip and the diamond tip is used as the aforementioned cutting edge. Thus, the cutting tool of the present invention exhibits both improved durability and a cutting performance when cutting the lead-free copper-based bearing alloy described above comparable to the cutting performance when cutting a conventional lead-containing copper-based bearing alloy.

Possible reasons for this improved performance are as follows. When the diamond tip serving as the cutting edge of the cutting tool impinges on the hard particles contained in the lead-free copper-based bearing alloy during the cutting of the lead-free copper-based bearing alloy, a part of the diamond particles comprising the diamond tip may become dislodged. The frequency with which the diamond particles become dislodged is higher when cutting a lead-free copper-based bearing alloy than when cutting a conventional lead-containing copper-based bearing alloy, and this phenomenon is believed to cause the problems described above.

It is difficult to completely prevent diamond particles from becoming dislodged when the hard particles are metal phosphide, boride, or carbide particles which have a comparatively high degree of hardness. Moreover, when diamond particles become dislodged, recess portions corresponding to the size of the diamond particles are formed in the cutting edge, and as the number of recess portions increases, irregularities in the shape of the cutting edge become larger, which leads to deterioration of the cutting performance.

Almost all conventional diamond tips serving as cutting edges employ diamond particles having a comparatively large average particle diameter (D50) between 2 μm and 10 μm, whereas in the present invention, the employed diamond tip is formed by sintering extremely small-diameter diamond particles having an average particle diameter (D50) between 0.2 μm and 1.6 μm. Therefore, even when diamond particles become dislodged in an identical proportion, the degree of irregularity in the shape of the cutting edge is smaller in the present invention compared to the related art. Hence, when used to cut the lead-free copper-based bearing alloy described above, the cutting tool of the present invention exhibits superior durability and an improved cutting performance in comparison with a conventional cutting tool.

### BRIEF DESCRIPTION OF THE DRAWINGS

FIG. 1 is a perspective view showing the overall shape of a cutting tool according to a first exemplary embodiment;

FIG. 2 is an illustrative view showing the peripheral constitution of a diamond tip according to the first exemplary embodiment;

FIG. 3 is an illustrative view showing the structure of the diamond tip according to the first exemplary embodiment;

FIG. 4 is an illustrative view showing a rake angle and a clearance angle of the cutting tool according to the first exemplary embodiment; and

FIG. 5 is an illustrative view showing measurement results of an amount of wear accompanying processing using various cutting tools, according to the first embodiment.

### DETAILED DESCRIPTION OF THE PREFERRED EMBODIMENTS

As described above, a diamond tip of a cutting tool according to the present invention is constituted by a sintered body formed by sintering diamond particles having an average particle diameter (D50) between 0.2 μm and 1.6 μm. When the average particle diameter of the diamond particles is less than 0.2 μm, the particle diameter becomes more likely to undergo abnormal growth during the sintering process such that coarse particles are formed. When the average particle diameter exceeds 1.6 μm, on the other hand, sufficient improvements in durability and cutting performance cannot be obtained.

Note that the average particle diameter D50 may be defined as “the particle diameter at which the accumulated mass from the small particle diameter side reaches 50%” on a so-called particle diameter distribution chart showing the particle diameter on the abscissa and the percentage by mass of the particles corresponding to the particle diameter on the ordinate, and measurement thereof may be performed using a so-called laser analysis-type particle size distribution measurement method.

Further, the cross section the cutting edge described above preferably has a curved surface shape having a radius of curvature between 10 μm and 50 μm. In other words, the cutting edge, i.e. the corner portion formed on the line of intersection between the rake surface and the clearance surface, preferably has curved surface shape having a radius of curvature within the aforementioned predetermined range when seen from the cross-section thereof In this case, a plurality of diamond particles having particle diameters considerably smaller than this radius of curvature gather to form the curved surface shape. Therefore, during cutting, there is a high probability of a plurality of diamond particles coming into contact with the lead-free copper-based bearing alloy, which serves as a cutting subject material, at the same time. Thus, the likelihood of diamond particles becoming dislodged can be reduced. When the radius of curvature is less than 10 μm, the number of diamond particles coming into contact with the cutting subject material at the same time during cutting decreases, and as a result, the number of diamond particles which become dislodged cannot be reduced. When the radius of curvature exceeds 50 μm, on the other hand, an increase in cutting resistance occurs.

Further, the clearance angle, which is the angle formed by the clearance surface in relation to the cutting direction of the cutting tool, is preferably between 2° and 7°. More specifically, in a typical cutting tool, the clearance angle is often set at a comparatively large angle of 11° or more, but in the application-specific cutting tool of the present invention, the clearance angle is preferably made smaller than that of a typical cutting tool such that the angle remains within the aforementioned specific range. In so doing, a region including diamond particles that support the diamond particles of the cutting edge(which come into contact with the cutting subject material during cutting) from the rear can be enlarged, and the number of diamond particles that become dislodged can be reduced even further. When the clearance angle is less than 2°, the clearance surface is more likely to come into contact with the subject material being cut when cutting an inner diameter portion of a cylindrical member. When the clearance angle exceeds 7°, on the other hand, it becomes difficult to sufficiently obtain the effects described above.

Note that in order to provide a clearance surface having a clearance angle between 2° and 7°, it is preferable to provide a standard clearance surface having a clearance angle of approximately 11°, and then perform additional processing near the tip end thereof to form a clearance surface having a clearance angle between 2° and 7°.

Further, the rake angle, which is the angle formed by the rake surface in relation to a direction orthogonal to the cutting direction of the cutting tool, is preferably set between +5° and −10°. By limiting the rake angle to an angle within this specific range, cutting can be performed with stability. When the rake angle exceeds −10°, a dramatic increase in the surface pressure applied to the cutting subject may occur, leading to irregularities in the surface texture of the cut surface. When the rake angle exceeds +5°, on the other hand, the shearing strength of the cutting edge tip decreases, thereby increasing the likelihood of damage or breakage on the cutting edge.

Further, when the hard particles contained in the bearing alloy have an average particle diameter (D50) between 10 μm and 70 μm, the actions and effects of the cutting tool according to the present invention are exhibited even more effectively. More specifically, when the average particle diameter of the hard particles contained in the bearing alloy is within this specific range, the particle diameter of the diamond particles of the cutting tool is considerably smaller than that of the hard particles, and therefore the actions and effects of the present invention are exhibited effectively. When the average particle diameter of the hard particles in the bearing alloy is less than 10 μm, on the other hand, the performance thereof as a bearing alloy may deteriorate, and when the average particle diameter exceeds 70 μm, the actions and effects of the present invention may be reduced.

### First Embodiment

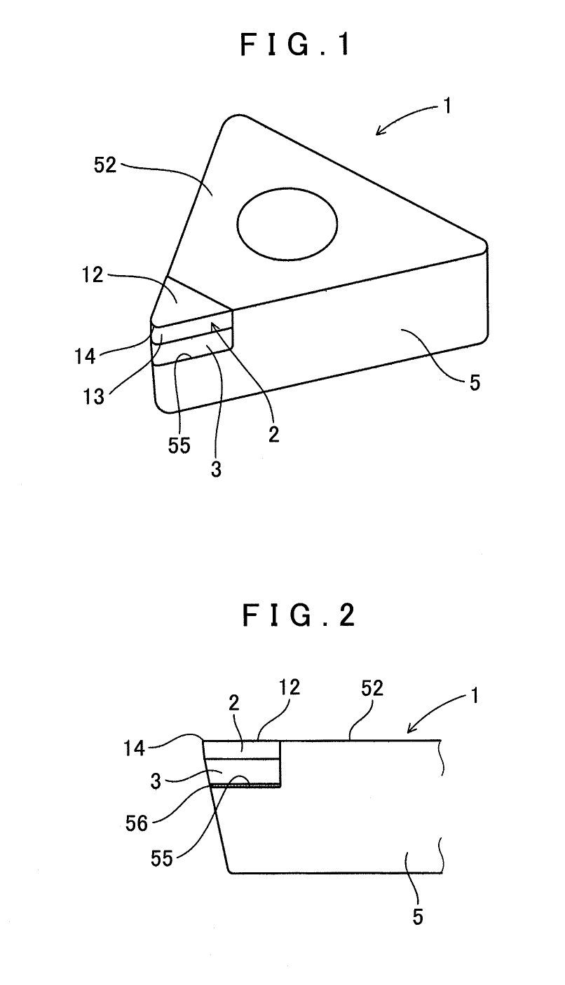

A cutting tool according to an embodiment of the present invention will be described using FIGS. 1 to 4.

A cutting tool 1 according to this embodiment is a cutting tool for cutting a lead-free copper-based bearing alloy comprising 75 to 95% by mass Cu, 1 to 15% by mass Bi, and 1 to 10% by mass hard particles comprising metal phosphide, boride, or carbide.

The cutting tool 1 includes a rake surface 12, a clearance surface 13, and a cutting edge 14 formed on a line of intersection between the rake surface 12 and clearance surface 13, and a tip end site including the cutting edge 14 comprising a diamond tip 2. The diamond tip 2 comprises a sintered body formed by sintering diamond particles 21 having an average particle diameter (D50) between 0.2 μm and 1.6 μm.

The cutting tool 1 will now be described in detail.

As shown in FIGS. 1 and 2, the cutting tool 1 of this embodiment is formed by moving back an angle portion on a rake surface 52 side of a substantially triangular tool main body portion 5 and disposing the diamond tip 2, which is formed on a back metal portion 3 to be described below, on a disposal surface 55 provided substantially parallel with the rake surface 52.

As shown in FIGS. 1 and 2, the diamond tip 2 is adhered to the back metal portion 3 so as to be used in a two-layer structure form. The back metal portion 3 is constituted by a Tungsten Carbide-Cobalt(WC-Co) alloy, which is a material that is widely used as a back metal.

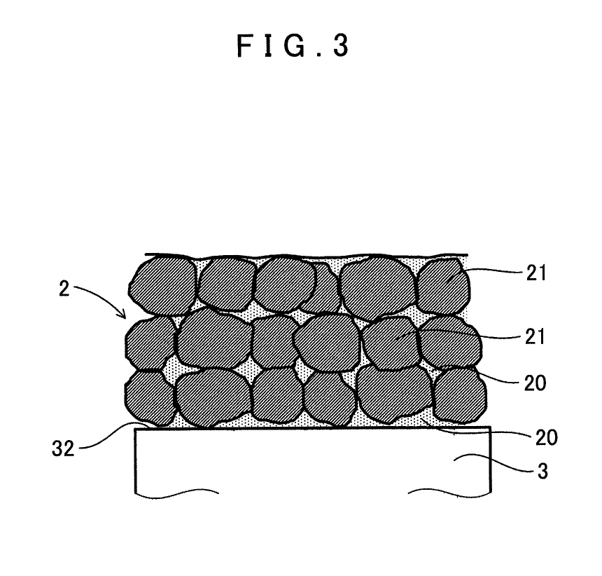

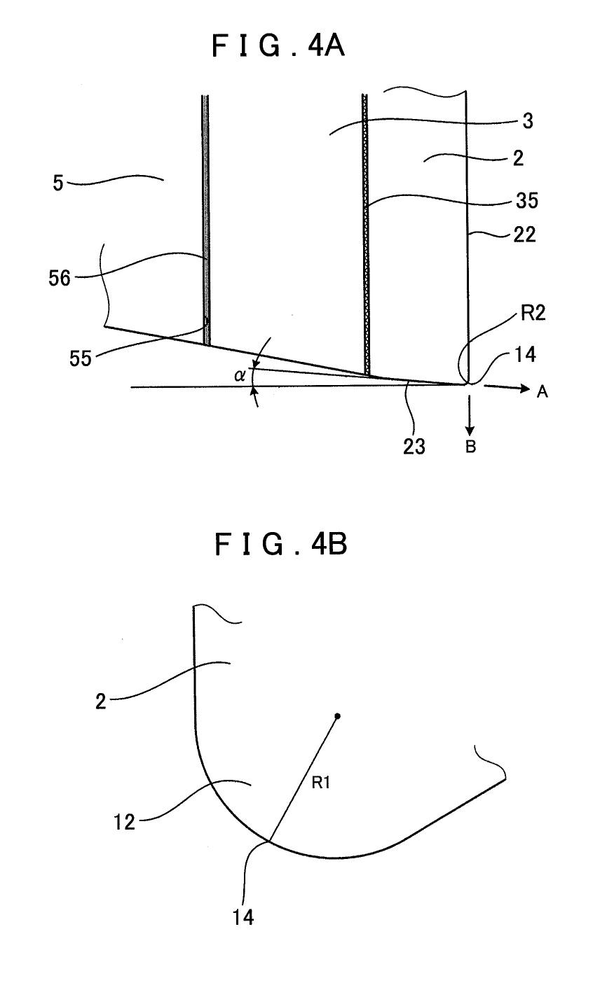

As shown in FIG. 3, the diamond tip 2 is formed by blending the diamond particles 21 having an average particle diameter (D50) between 0.2 μm and 1.6 μm with a Co catalyst 20, disposing the resulting mixture on a rake surface side front surface 32 of the back metal portion 3, and then performing high-temperature, high-pressure sintering thereon. A diffusion layer 35 (see FIG. 4A) formed by mutual diffusion of the Co catalyst 20 and the WC-Co of the back metal portion 3 is formed between the back metal portion 3 and the diamond tip 2.

As shown in FIG. 2, the two-layer structure tip portion is disposed on the tool main body portion 5 by adhering a rear surface of the back metal portion 3 to the disposal surface 55 via a wax material 56.

As shown in FIGS. 1 and 4B, the cutting tool 1 is shaped such that the rake surface 12 of the diamond tip 2 is substantially triangular and the angle portion forms an arc. The cutting edge 14 is formed in a curved shape in alignment with this arc.

Further, as shown in FIG. 4B, the cutting edge 14 takes a curved surface shape having a radius of curvature R1 between 0.2 and 1.6 mm. In this embodiment, the radius of curvature R1=0.8 mm, which is the most typical value.

Further, as shown in FIG. 4A, a clearance angle α, which is the angle formed by the clearance surface 23 in relation to a cutting direction A of the cutting tool 1, is set at 5°.

As shown in the same drawing, a rake angle, which is the angle formed by the rake surface 22 in relation to a direction B orthogonal to the cutting direction of the cutting tool 1, is set at 0° on a substantially triangular single tool unit.

As shown in the same drawing, the sectional shape of the cutting edge 14 is a curved surface shape having a radius of curvature R2 between 10 and 50 μm.

In this embodiment, when a lead-free copper-based bearing alloy (manufactured by Taiho Kogyo Co. Ltd., product number: HB-200X) was cut using the cutting tool 1 described above, a substantially identical cutting performance and a substantially identical lifespan to a conventional cutting tool cutting a conventional lead-containing copper-based bearing alloy were obtained.

Note that in this embodiment, the shape of the tool main body portion 5 is described as triangular, but a square shape or any other shape may alternatively be employed.

The following test was performed to determine the effectiveness of the cutting tool according to the first embodiment quantitatively.

First, a conventional cutting tool was prepared for comparison with the cutting tool of the first embodiment. The conventional cutting tool differs from the cutting tool of the first embodiment in that the average particle diameter (D50) of the diamond particles which comprise the diamond tip is increased to a range of 2 to 10 μm, but otherwise has an identical structure to that of the first embodiment.

A lead-free copper-based bearing alloy (manufactured by Taiho Kogyo Co. Ltd., product number: HB-200X) comprising: 87±3% by mass Cu, 6.5±1.5% by mass Bi, and 2.5±1.0% by mass hard particles comprising Iron (Fe) phosphide with an average particle diameter (D50) of 25 was prepared as the cutting subject material.

The test was performed to measure the amount of wear (μm) on the cutting edge when cutting is performed repeatedly on a lead-free copper-based bearing alloy. Through the test, a relationship between the cumulative cutting distance (km) and the amount of wear (μm) was determined.

The conditions of the cutting were set as follows: cutting speed=300 m/minute; feed rate=10 mm/rev; stock amount=0.15 mm; and R1 (nose R)=0.8 mm.

The wear amount is a dimension taken in a direction perpendicular to the rake surface 12, and was set as the maximum depth of a worn (damaged) part occurring on the clearance surface side, using the position of the rake surface 12 as a reference (zero).

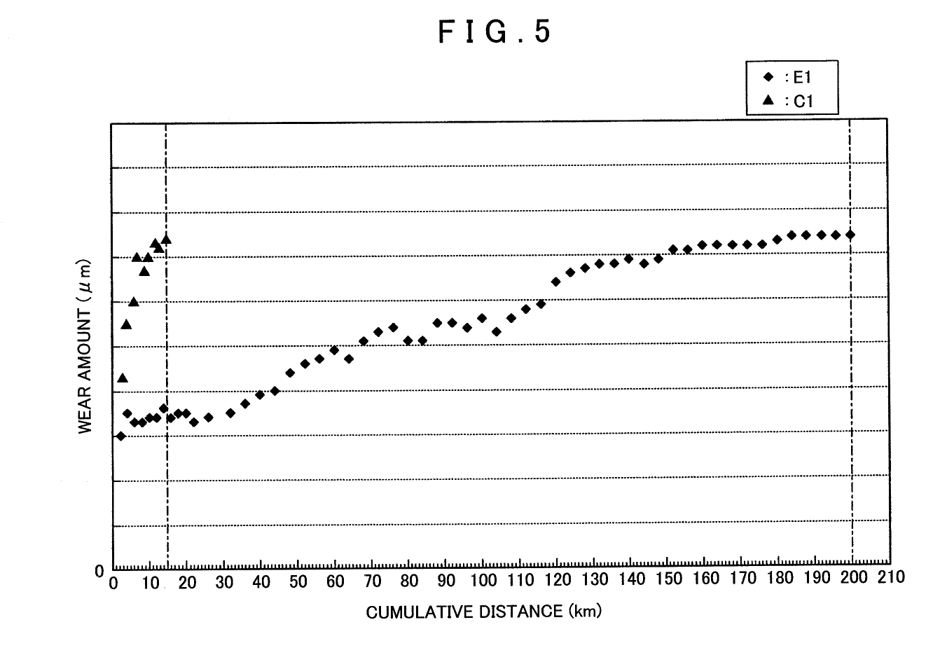

The results are shown in FIG. 5. In this drawing, the cutting distance (km) is shown on the abscissa and the wear amount (μm) is shown on the ordinate. The case employing the cutting tool of the first embodiment was plotted using the reference symbol E1, and the case employing the cutting tool provided for comparison was plotted using the reference symbol C1.

As is evident from the drawing, the advancement of wear on the cutting tool was much slower in the case where the cutting tool of the first embodiment, which serves as an example of the present invention, was used (E1) than in the case where the cutting tool provided for comparison was used (C1).

Further, in the case for comparison (C1), rib-shaped cutting tracks appeared on the cutting surface as the amount of wear increased, leading to a large reduction in cutting precision (surface roughness), whereas in the first embodiment (E1), this reduction in cutting precision was not observed until a cutting distance of at least 200 km was reached.

From the above results, it can be seen that the cutting tool according to the first embodiment of the present invention is highly suitable for cutting a lead-free copper-based bearing alloy.

What is claimed is:

1. A cutting tool for cutting a lead-free copper-based bearing alloy, said alloy comprising 75 to 95% by mass Cu, 1 to 15% by mass Bi, and 1 to 10% by mass hard particles comprising metal phosphide, boride, or carbide, said cutting tool comprising
a rake surface,
a clearance surface, and
a cutting edge formed on a line of intersection between the rake surface and the clearance surface, wherein
a tip end site including the cutting edge comprises a diamond tip, and
the diamond tip comprises a sintered body formed by sintering diamond particles having an average particle diameter (D50) between 0.2 μm and 1.6 μm.

2. The cutting tool according to claim 1, wherein a cross section of the cutting edge has a curved surface shape with a radius of curvature between 10 μm and 50 μm.

3. The cutting tool according to claim 1, wherein a clearance angle, which is an angle formed by the clearance surface in relation to a cutting direction of the cutting tool, is set between 2° and 7°.

4. The cutting tool according to claim 1, wherein a rake angle, which is an angle formed by the rake surface in relation to a direction orthogonal to the cutting direction of the cutting tool, is set between +5° and −10°.

5. The cutting tool according to claim 1, wherein the hard particles contained in the bearing alloy have an average particle diameter (D50) between 10 μm and 70 μm.
